(19) United States
(12) Patent Application Publication
(10) Pub. No.: US 2022/0069330 A1
(43) Pub. Date: Mar. 3, 2022

(54) Fuel Cell and Fuel Cell Vehicle

(71) Applicants: Hyundai Motor Company, Seoul (KR); Kia Motors Corporation, Seoul (KR)

(72) Inventors: Seung Jun Yeon, Yongin-si (KR); Ju Hyeop Lee, Yongin-si (KR); Hyun Jae Lee, Seoul (KR)

(21) Appl. No.: 17/157,562

(22) Filed: Jan. 25, 2021

(30) Foreign Application Priority Data
Sep. 1, 2020 (KR) 10-2020-0110833

(51) Int. Cl. H01M 8/2475; H01M 8/248; H01M 8/04119

(52) U.S. Cl. CPC H01M 8/2475; H01M 2250/20; H01M 8/04141; H01M 8/248

(57) ABSTRACT

A fuel cell includes a cell stack including a plurality of unit cells stacked in a forward travel direction of a vehicle, an enclosure disposed so as to surround at least a portion of the cell stack, and an end plate configured to support the plurality of unit cells of the cell stack, wherein the end plate has a reactant gas inlet and a reactant gas outlet disposed further forward than the cell stack in the forward travel direction of the vehicle.

### CROSS-REFERENCE TO RELATED APPLICATIONS

This application claims priority to Korean Patent Application No. 10-2020-0110833, filed on Sep. 1, 2020, which application is hereby incorporated herein by reference.

### TECHNICAL FIELD

The present invention relates to a fuel cell vehicle.

### BACKGROUND

In general, compared to conventional power generation methods, a fuel cell is highly efficient in power generation and causes no emission of pollutants attributable to power generation. Thus, the fuel cell is predicted to be a major power generation technology in the future, and is in the spotlight as a next-generation power source because it is capable of employing various kinds of fuel.

The fuel cell is a device that converts chemical energy, generated by oxidizing a material having activity involving hydrogen (e.g. LNG, LPG, methanol, etc.) through an electrochemical reaction, into electrical energy. In general, a fuel cell uses hydrogen, which is easily produced from natural gas, and oxygen in the air.

With the development of such a fuel cell, power systems for replacing internal combustion engines have been developed in order to solve problems of energy conservation, environmental pollution, and global warming that have recently arisen.

The produced water generated in the fuel cell is discharged due to the flow of a residual gas. However, when the fuel cell stack is inclined or the flow rate of the residual gas is not sufficiently high, the produced water is not smoothly discharged to the outside of the stack.

In particular, in the state in which the flow rate of the residual gas is not sufficiently high, when the fuel cell stack is inclined, the produced water collects around the portion of the cell that is located at the lowest point, resulting in deterioration in the performance of the cell.

### SUMMARY

The present invention relates to a fuel cell vehicle. Particular embodiments relate to a fuel cell capable of smoothly discharging produced water generated in a fuel cell stack and to a fuel cell vehicle using the same.

Accordingly, embodiments of the present invention are directed to a fuel cell and a fuel cell vehicle that substantially obviate one or more problems due to limitations and disadvantages of the related art.

An embodiment of the present invention provides a fuel cell capable of smoothly discharging produced water generated in a fuel cell stack and a fuel cell vehicle using the same.

In order to accomplish the above and other features, a fuel cell according to an embodiment of the present invention may include a cell stack including a plurality of unit cells stacked in a travel direction of a vehicle, an enclosure disposed so as to surround at least a portion of the cell stack, and an end plate disposed at each of both end portions of the cell stack in order to support and fix the plurality of unit cells. The end plate may have a reactant gas inlet and a reactant gas outlet disposed so as to be oriented in the travel direction of the vehicle.

In the fuel cell according to an exemplary embodiment of the present invention, the reactant gas inlet and the reactant gas outlet may be disposed further forwards than the cell stack in the travel direction of the vehicle.

In the fuel cell according to an exemplary embodiment of the present invention, the reactant gas outlet may be located closer to the ground than the reactant gas inlet.

In the fuel cell according to an exemplary embodiment of the present invention, an air outlet may be located so as to be spaced apart from an air inlet in the diagonal direction, and a hydrogen outlet may be located so as to be spaced apart from a hydrogen inlet in the diagonal direction.

A fuel cell vehicle according to an exemplary embodiment of the present invention may include a fuel cell, a fuel cell frame on which the fuel cell is mounted, and a produced water drain unit disposed under the fuel cell frame.

In the fuel cell vehicle according to an exemplary embodiment of the present invention, the produced water drain unit may be located closer to the ground than the reactant gas outlet of the fuel cell.

In the fuel cell vehicle according to an exemplary embodiment of the present invention, the produced water drain unit may be connected to an air inlet and an air outlet of the fuel cell.

In the fuel cell vehicle according to an exemplary embodiment of the present invention, the produced water drain unit may be oriented at the same angle as the reactant gas inlet and the reactant gas outlet of the fuel cell.

### BRIEF DESCRIPTION OF THE DRAWINGS

Arrangements and embodiments may be described in detail with reference to the following drawings in which like reference numerals refer to like elements and wherein:

FIG. 1 is a perspective view showing the external appearance of a fuel cell according to an embodiment;

FIG. 2 is a cross-sectional view taken along line I-I′ in FIG. 1;

FIG. 3 is a cross-sectional view for explaining the cell stack shown in FIG. 2;

FIG. 4 is a cross-sectional view taken along line III-III′ in FIG. 1;

FIG. 5 is a cross-sectional view taken along line II-II′ in FIG. 1, and illustrates the flow of reactant gases in the fuel cell according to embodiments of the present invention;

FIG. 6 is a cross-sectional view illustrating the interior of a cell stack in the fuel cell according to embodiments of the present invention when a vehicle travels downhill;

FIG. 7 is a cross-sectional view taken along line III-III′ in FIG. 1 when a vehicle travels downhill;

FIG. 8 is a cross-sectional view illustrating the interior of the cell stack in the fuel cell according to embodiments of the present invention when a vehicle travels uphill;

FIG. 9 is a view schematically illustrating the configuration of a fuel cell system of a fuel cell vehicle according to embodiments of the present invention; and

FIG. 10 is a view illustrating the displacement of components of the fuel cell system when the fuel cell vehicle according to embodiments of the present invention travels downhill.

### DETAILED DESCRIPTION OF ILLUSTRATIVE EMBODIMENTS

The present disclosure will now be described more fully hereinafter with reference to the accompanying drawings, in which various embodiments are shown. The examples, however, may be embodied in many different forms and should not be construed as being limited to the embodiments set forth herein. Rather, these embodiments are provided so that this disclosure will be more thorough and complete and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, a fuel cell 100 according to an embodiment will be described with reference to the accompanying drawings. The fuel cell 100 will be described using the Cartesian coordinate system (x-axis, y-axis, z-axis) for convenience of description. However, other different coordinate systems may be used. In the drawings, the x-axis, the y-axis, and the z-axis of the Cartesian coordinate system are perpendicular to each other. However, the embodiment is not limited thereto. That is, the x-axis, the y-axis, and the z-axis may cross each other.

A fuel cell includes a solid polymer electrolyte membrane, one side of which is provided with a cathode and the other side of which is provided with an anode. The fuel cell provides an external load with power generated through an electrochemical reaction between oxygen in the air supplied to the cathode and hydrogen supplied to the anode. The cathode, the anode, and the polymer electrolyte membrane are stacked to form one unit cell.

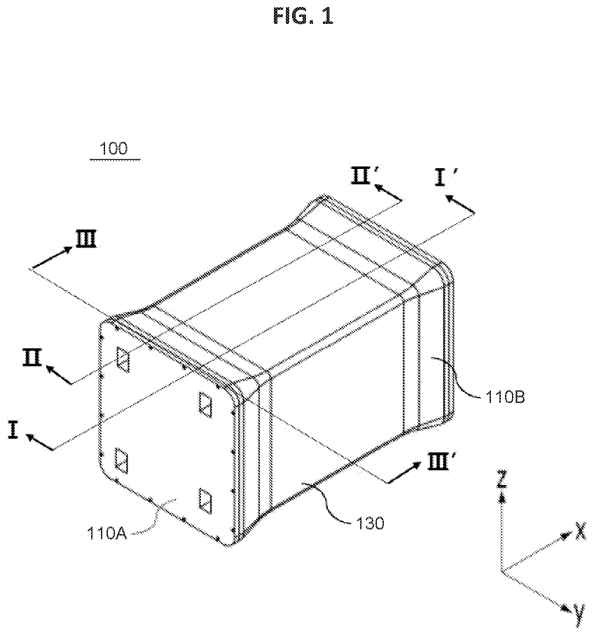

FIG. 1 is a perspective view showing the external appearance of a fuel cell according to an embodiment.

The fuel cell 100 shown in FIG. 1 may be, for example, a polymer electrolyte membrane fuel cell (or a proton exchange membrane fuel cell) (PEMFC), which has been studied most extensively as a power source for driving vehicles. However, the embodiment is not limited to any specific form of the fuel cell.

The fuel cell 100 includes end plates (pressing plates or compression plates) 110A and 110B disposed at respective ends of an enclosure 130.

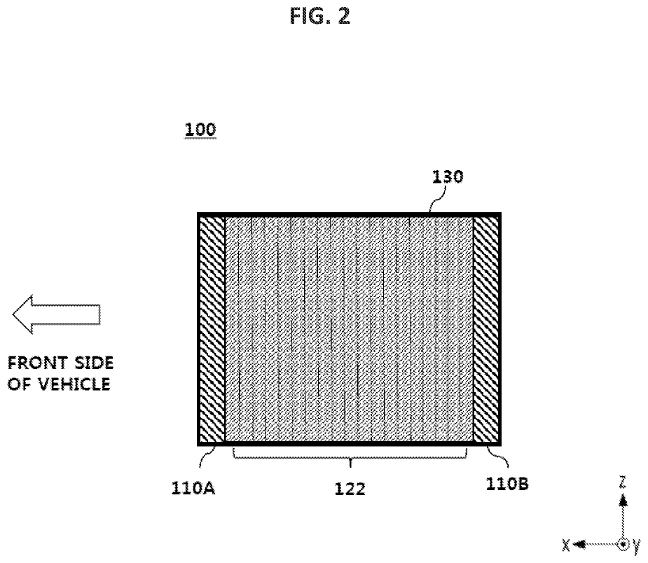

FIG. 2 is a cross-sectional view taken along line I-I′ in FIG. 1 in order to explain a cell stack 122. As shown in the drawings, the end plates 110A and 110B are disposed at respective ends of the cell stack 122 (or a stack module), which includes a plurality of unit cells stacked in the direction in which a vehicle travels, in order to support and fix the cell stack 122 composed of the plurality of unit cells.

That is, the first end plate 110A may be disposed at one of the two ends of the cell stack 122, and the second end plate 110B may be disposed at the other one of the two ends of the cell stack 122. Although the embodiment is described as being configured such that the end plates are disposed at both ends of the cell stack 122, the embodiment may alternatively be configured such that only the first end plate 110A is disposed at one end of the cell stack 122.

In this case, the first end plate 110A is disposed at a position further forward than the cell stack 122 in the direction in which the vehicle travels. The first end plate 110A has a reactant gas inlet and a reactant gas outlet.

Each of the end plates 110A and 110B may be configured such that a metal insert is surrounded by a plastic injection-molded product. The metal insert of each of the end plates 110A and 110B may have high rigidity to withstand internal surface pressure, and may be formed by machining a metal material.

The enclosure 130 may be disposed so as to surround at least a portion of the cell stack 122 that is disposed between the end plates 110A and 110B. According to an embodiment, the enclosure 130 may be disposed so as to surround all four surfaces of the cell stack 122. According to another embodiment, the enclosure 130 may be disposed so as to surround some of the four surfaces of the cell stack 122, and an additional member (not shown) may be disposed so as to surround the remaining ones of the four surfaces of the cell stack 122. For example, the enclosure 130 may be disposed so as to surround three surfaces among the four surfaces of the cell stack 122, and an additional member may be disposed so as to surround the remaining one of the four surfaces of the cell stack 122.

According to the embodiment, the enclosure 130 may serve as a clamping member to clamp the plurality of unit cells together with the end plates 110A and 110B in a first direction. In other words, the clamping pressure of the cell stack 122 may be maintained by the end plates 110A and 110B and the enclosure 13o, which have rigid structures.

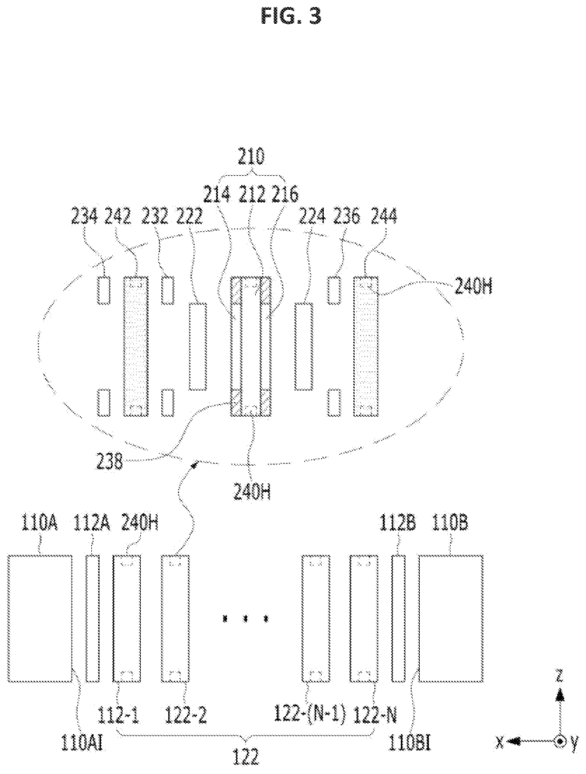

FIG. 3 is a cross-sectional view for explaining the cell stack shown in FIG. 2.

For convenience of description, the enclosure 130 shown in FIG. 1 is not illustrated in FIG. 3. Further, the fuel cell 100 according to the embodiment may include a cell stack having a configuration different from that illustrated in FIG. 3, and the embodiment is not limited to any specific structure of the cell stack.

The cell stack 122 may include a plurality of unit cells 122-1 to 122-N, which are stacked in the first direction (e.g. the x-axis direction). Here, “N” is a positive integer of 1 or greater, and may range from several tens to several hundreds. “N” may range, for example, from 100 to 300, and may preferably be 220. However, the embodiment is not limited to any specific value of “N”.

Each unit cell 122-n may generate 0.6 volts to 1.0 volt of electricity, on average 0.7 volts of electricity. Here, 1≤n≤N. Thus, “N” may be determined depending on the intensity of power to be supplied from the fuel cell 100 to a load. In the vehicle in which the fuel cell 100 is used, “load” may refer to a part of the vehicle that requires power.

Each unit cell 122-n may include a membrane electrode assembly (MEA) 210, gas diffusion layers (GDLs) 222 and 224, gaskets 232, 234 and 236, and separators (or bipolar plates) 242 and 244.

The membrane electrode assembly 210 has a structure in which catalyst electrode layers, in which an electrochemical reaction occurs, are attached to both sides of an electrolyte membrane through which hydrogen ions move. Specifically, the membrane electrode assembly 210 may include a polymer electrolyte membrane (or a proton exchange membrane) 212, a fuel electrode (or a hydrogen electrode or an anode) 214, and an air electrode (or an oxygen electrode or a cathode) 216. In addition, the membrane electrode assembly 210 may further include a sub-gasket 238.

Current-collecting plates 112A and 112B may be disposed between the inner surfaces 110AI and 110BI of the end plates 110A and 110B, which face the cell stack 122, and the cell stack 122. The current-collecting plates 112A and 112B serve to collect electrical energy, which is generated by the flow of electrons in the cell stack 122, and to supply the electrical energy to a load of the vehicle that uses the fuel cell 100.

The polymer electrolyte membrane 212 is disposed between the fuel electrode 214 and the air electrode 216.

Hydrogen, which is the fuel in the fuel cell 100, may be supplied to the fuel electrode 214 through the first separator 242, and air containing oxygen as an oxidizer may be supplied to the air electrode 216 through the second separator 244.

The hydrogen supplied to the fuel electrode 214 is decomposed into hydrogen ions (protons) (H+) and electrons (e−) by the catalyst. Only the hydrogen ions may be selectively transferred to the air electrode 216 through the polymer electrolyte membrane 212, and at the same time, the electrons may be transferred to the air electrode 216 through the separators 242 and 244, which are conductors. In order to realize the above operation, a catalyst layer may be applied to each of the fuel electrode 214 and the air electrode 216. The movement of the electrons described above causes the electrons to flow through an external wire, thus generating current. That is, the fuel cell wo may generate power due to the electrochemical reaction between hydrogen, which is fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (“condensate water” or “produced water”).

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 serve to uniformly distribute hydrogen and oxygen, which are reactant gases, and to transfer the generated electrical energy. To this end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the first separator 242, and may be electrically conductive. The second gas diffusion layer 224 may serve to diffuse and uniformly distribute air supplied as a reactant gas through the second separator 244, and may be electrically conductive. Each of the first and second gas diffusion layers 222 and 224 may be a microporous layer in which fine carbon fibers are combined.

The gaskets 232, 234 and 236 may serve to maintain the airtightness and clamping pressure of the cell stack at an appropriate level with respect to the reactant gases and the coolant, to disperse the stress when the separators 242 and 244 are stacked, and to independently seal the flow paths. As such, since airtightness and watertightness are maintained by the gaskets 232, 234 and 236, the flatness of the surfaces that are adjacent to the cell stack 122, which generates power, may be secured, and thus surface pressure may be distributed uniformly over the reaction surface of the cell stack 122.

The separators 242 and 244 may serve to move the reactant gases and the cooling medium and to separate each of the unit cells from the other unit cells. In addition, the separators 242 and 244 may serve to structurally support the membrane electrode assembly 210 and the gas diffusion layers 222 and 224 and to collect the generated current and transfer the collected current to the current-collecting plates 112.

The separators 242 and 244 may be disposed outside the gas diffusion layers 222 and 224, respectively. That is, the first separator 242 may be disposed on the left side of the first gas diffusion layer 222, and the second separator 244 may be disposed on the right side of the second gas diffusion layer 224.

The first separator 242 serves to supply hydrogen as a reactant gas to the fuel electrode 214 through the first gas diffusion layer 222. The second separator 244 serves to supply air as a reactant gas to the air electrode 216 through the second gas diffusion layer 224. In addition, each of the first and second separators 242 and 244 may form a channel through which a cooling medium (e.g. coolant) may flow. Furthermore, the separators 242 and 244 may be formed of a graphite-based material, a composite graphite-based material, or a metal-based material.

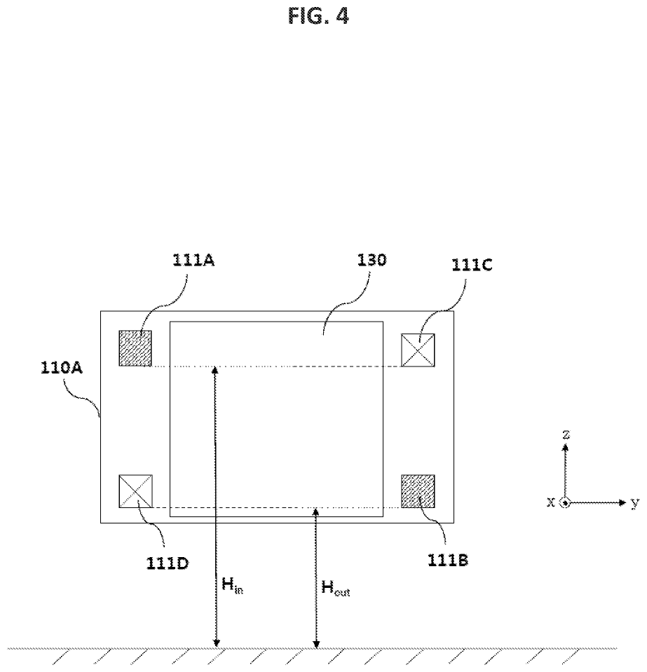

FIG. 4 is a cross-sectional view taken along line III-III′ in FIG. 1.

As shown in the drawings, the first end plate 110A may include a plurality of reactant gas inlets/outlets (or communication portions) 111A, 111B, 111C and 111D in upper and lower regions thereof on the left and right sides of the enclosure 130. Here, the reactant gas inlets/outlets may include reactant gas inlets 111A and 111C and reactant gas outlets 111B and 111D.

Hydrogen (H₂) and air, which are reactant gases necessary in the membrane electrode assembly 210, may be introduced from the outside into the cell stack 122 through the reactant gas inlets 111A and 111C. Air contains oxygen (O₂). Air is introduced into the air inlet 111A. Hydrogen (H₂) is introduced into the hydrogen inlet 111C.

Gas or liquid, in which the reactant gases humidified and supplied to the cell and the condensate water generated in the cell are combined, may be discharged to the outside of the fuel cell wo through the reactant gas outlets 111B and 111D. Air is discharged through the air outlet 111B. Hydrogen is discharged through the hydrogen outlet 111D.

In addition, the cooling medium may flow from the outside into the cell stack 122 through the reactant gas inlets 111A and 111C, and may flow to the outside through the reactant gas outlets 111B and 111D. In this way, the reactant gas inlets/outlets 111A, 111B, 111C and 111D allow the fluid to flow into and out of the membrane electrode assembly 210.

The reactant gas outlets 111B and 111D are located closer to the ground than the reactant gas inlets 111A and 111C. That is, the height Hₒᵤₜ of the reactant gas outlets 111B and 111D from the ground is less than the height Hᵢₙ, of the reactant gas inlets 111A and 111C from the ground. The air outlet 111B, among the reactant gas outlets, is located so as to be spaced apart from the air inlet 111A in the diagonal direction. Similarly, the hydrogen outlet 111D, among the reactant gas outlets, is located so as to be spaced apart from the hydrogen inlet 111C in the diagonal direction.

The reactant gas outlets 111B and 111D are illustrated in the drawings as being located at positions higher than the lower end portion of the reaction part, in which produced water 200 is generated. However, this is merely given by way of example. Even if the reactant gas outlets 111B and 111D are located at the same height as the lower end portion of the reaction part or are located at positions lower than the lower end portion of the reaction part, embodiments of the present invention may still exhibit the effect of improved discharge of produced water.

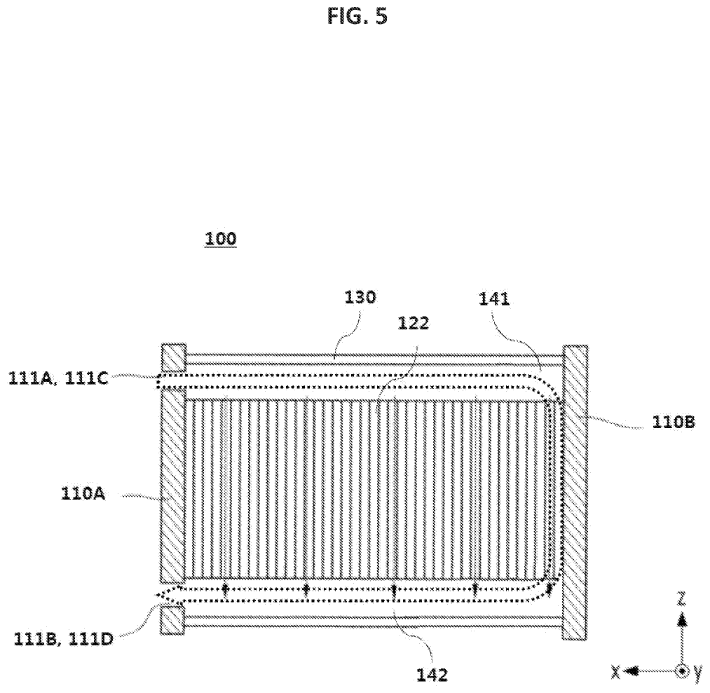

FIG. 5 is a cross-sectional view taken along line II-II′ in FIG. 1, and illustrates the flow of reactant gases in the fuel cell according to embodiments of the present invention. The reactant gases and air flow into the cell stack 122 through the reactant gas inlets 111A and 111C, cause an electrochemical reaction while passing through the cell stack 122, and flow outside through the reactant gas outlets 111B and 111D. The cell stack 122 includes a supply manifold 141, which receives reactant gases, and a discharge manifold 142, in which a residual gas discharged from the electrolyte membrane collects and through which the residual gas is discharged to the outside.

A fuel gas and an oxidizing gas are supplied as the reactant gases. A reformed gas containing hydrogen may be used as the fuel gas, and oxygen or air containing oxygen may be used as the oxidizing gas.

The produced water and residual gas generated as a result of the electrochemical reaction are discharged to the outside through the reactant gas outlets 111B and 111D. At this time, the flow rate of the produced water that is discharged is proportional to the flow rate of the residual gas flowing out together with the produced water.

The air inlet 111A is disposed at the front end of the cell stack 122 in the direction in which the vehicle travels, thereby receiving air from the front end of the vehicle. Accordingly, the intake differential pressure is effectively realized, and thus the amount of power consumed by the air compressor may be reduced.

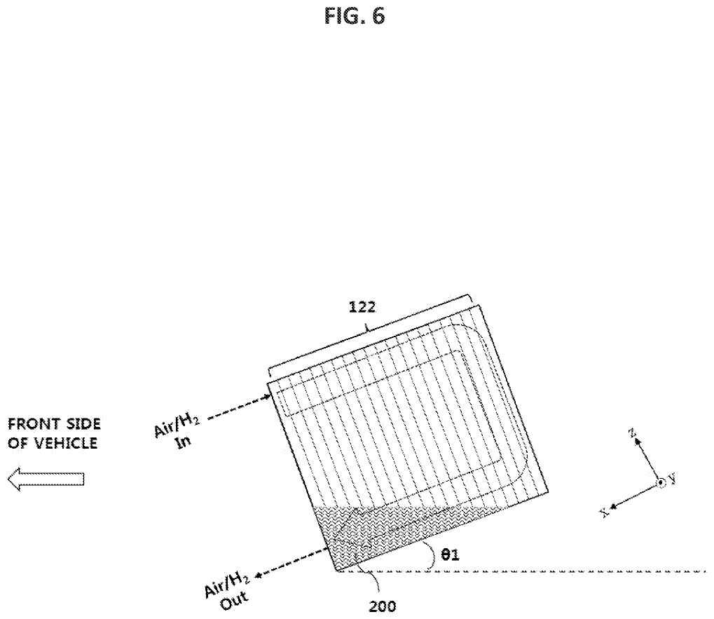

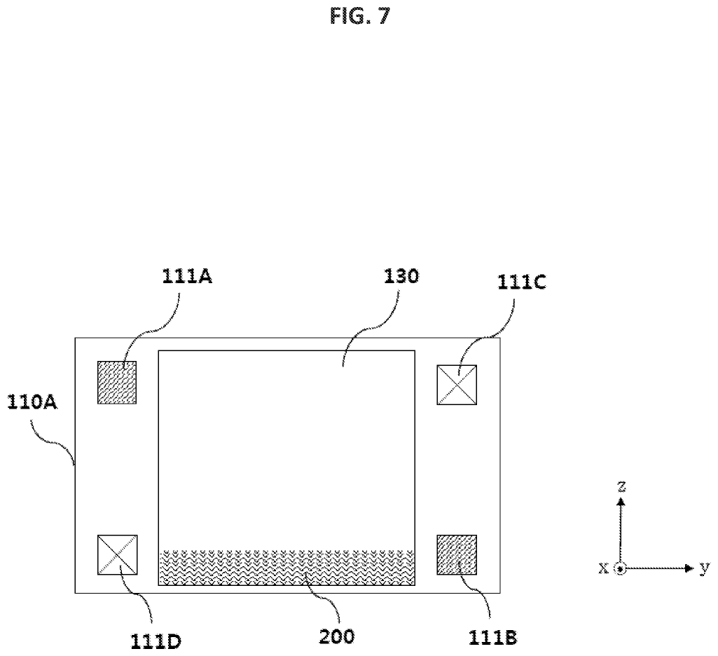

FIG. 6 is a cross-sectional view illustrating the interior of the cell stack in the fuel cell according to embodiments of the present invention when the vehicle travels downhill, and FIG. 7 is a cross-sectional view taken along line III-III′ in FIG. 1 when the vehicle travels downhill. For convenience of description, the first and second end plates 110A and 110B are not illustrated in FIG. 6.

When the vehicle travels downhill, the produced water 200 generated by the electrochemical reaction collects on the lower end portion of the reaction part of the unit cell, which is the closest to the direction in which the vehicle travels due to gravity. In general, when the vehicle travels downhill, the vehicle is driven in a low-power (low-flow) mode. Therefore, because the flow rate of the reactant gases is not high, a large amount of external force for discharging water is not generated. However, since the produced water 200 collects in the area close to the reactant gas outlets 111B and 111D, it is possible to effectively discharge the produced water 200. When the angle θ₁ at which the vehicle travels downhill is about 10° or more, embodiments of the present invention are capable of exhibiting an effect of further improved discharge of produced water.

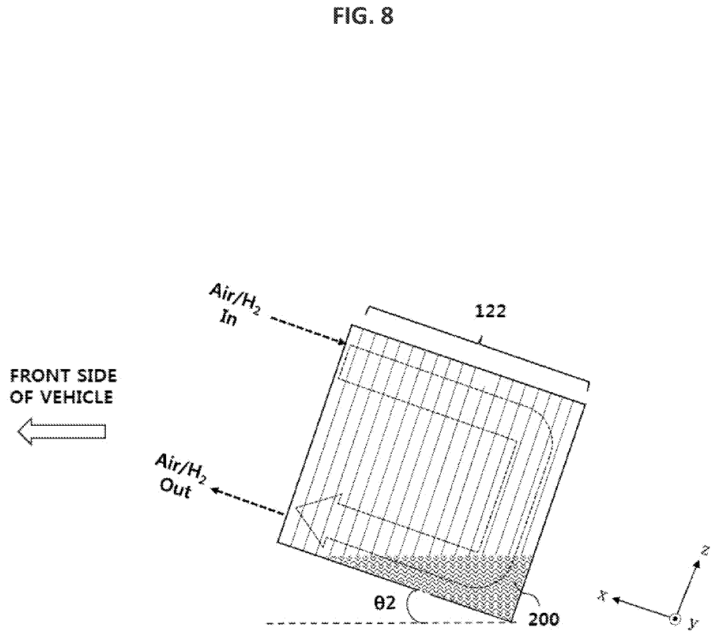

FIG. 8 is a cross-sectional view illustrating the interior of the cell stack in the fuel cell according to embodiments of the present invention when the vehicle travels uphill. Contrary to the downhill travel shown in FIG. 6, the produced water 200 collects on the side opposite the reactant gas outlets 111B and 111D. In general, when the vehicle travels uphill, the vehicle is driven in a high-power mode. Therefore, in order for the cell stack to satisfy the power required by the vehicle, a large amount of hydrogen and air are introduced from the air compressor into the reactant gas inlets 111A and 111C. Since a sufficiently large amount of reactant gases are introduced, the produced water is effectively discharged to the outside through the reactant gas outlets 111B and 111D. Due to the characteristics of the fuel cell in which the temperature of the cell stack rises as the power increases, the relative amount of produced water remaining in the cell stack decreases.

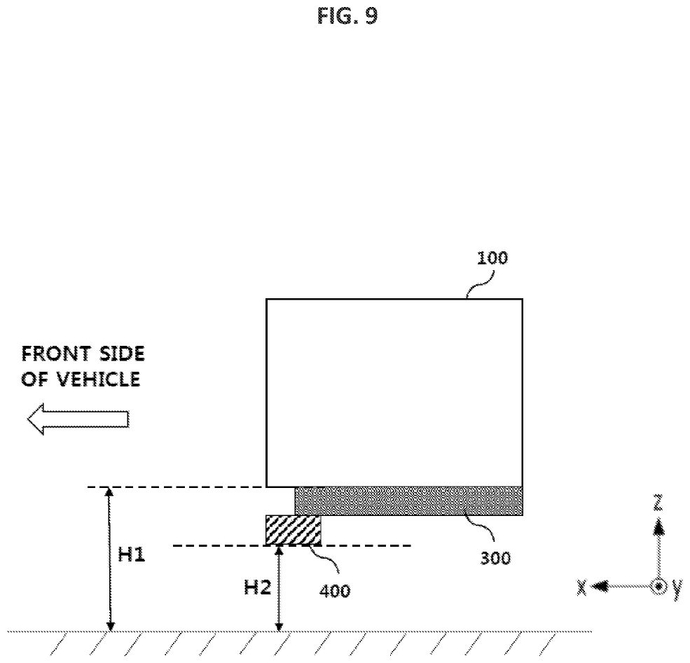

FIG. 9 is a view schematically illustrating the configuration of a fuel cell system of a fuel cell vehicle according to embodiments of the present invention. As illustrated, the fuel cell moo is disposed on the upper end of a fuel cell frame 300. A produced water drain unit 400 is disposed under the fuel cell frame 300. The produced water drain unit 400 is located closer to the ground than the reactant gas outlets 111B and 111D of the fuel cell moo. Accordingly, the produced water discharged from the reactant gas outlets 111B and 111D may be easily discharged to the produced water drain unit 400 due to gravity.

Although not illustrated, the produced water drain unit 400 may be connected to the air inlet 111A and the air outlet 111B of the fuel cell moo via a connection member such as a hose or a duct. The produced water drain unit 400 may take the form of a humidifier, as a constituent component of the fuel cell system, and may serve to supply moisture. Alternatively, the produced water drain unit 400 may take the form of an exhaust duct for discharging the produced water to the outside of the vehicle.

The height H1 from the ground to the lower portion of the fuel cell moo, particularly to the reactant gas outlets 111B and 111D, is greater than the height H2 from the ground to the lower portion of the produced water drain unit 400.

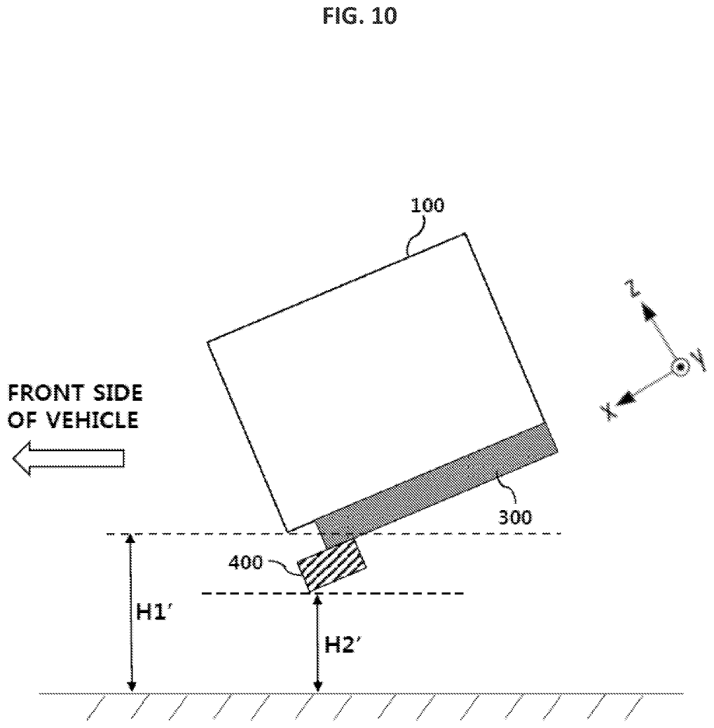

FIG. 10 is a view illustrating the displacement of the components of the fuel cell system when the fuel cell vehicle according to embodiments of the present invention travels downhill. As illustrated, the produced water drain unit 400 and the fuel cell moo are mounted to the fuel cell frame 300 by, for example, being bolted thereto. Accordingly, when the vehicle travels downhill or uphill, the produced water drain unit 400 and the reactant gas outlets 111B and 111D are oriented at the same angle. Therefore, when the vehicle travels downhill, the height H1′ from the ground to the lower portion of the fuel cell moo, particularly to the reactant gas outlets 111B and 111D, is greater than the height H2′ from the ground to the lower portion of the produced water drain unit 400.

As is apparent from the above description, in a fuel cell and a fuel cell vehicle according to embodiments of the present invention, a first end plate, in which reactant gas inlets and reactant gas outlets are formed, is located further forwards than a cell stack in the direction in which a vehicle travels, whereby produced water generated in the cell stack is smoothly discharged.

In addition, when the vehicle, in which the cell stack of the fuel cell is mounted in a manner of being stacked in the direction in which the vehicle travels, travels downhill or uphill, it is possible to efficiently prevent a flooding phenomenon in the cell stack without separate control logic or a separate operating part such as a valve.

The above-described various embodiments may be combined with each other without departing from the objects of the present disclosure unless they are contrary to each other. In addition, for any element that is not described in detail of any of the various embodiments, reference may be made to the description of an element having the same reference numeral in another embodiment.

While the present disclosure has been particularly shown and described with reference to exemplary embodiments thereof, these embodiments are only proposed for illustrative purposes and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell, comprising:
a cell stack comprising a plurality of unit cells stacked in a forward travel direction of a vehicle;
an enclosure disposed so as to surround at least a portion of the cell stack; and
an end plate configured to support the plurality of unit cells of the cell stack, wherein the end plate has a reactant gas inlet and a reactant gas outlet disposed further forward than the cell stack in the forward travel direction of the vehicle.

2. The fuel cell according to claim 1, wherein the end plate is disposed on at least one of two end portions of the cell stack.

3. The fuel cell according to claim 1, wherein the reactant gas outlet is located closer to a ground than the reactant gas inlet.

4. The fuel cell according to claim 3, wherein an air outlet is located so as to be spaced apart from an air inlet in a diagonal direction, and a hydrogen outlet is located so as to be spaced apart from a hydrogen inlet in a diagonal direction.

5. The fuel cell according to claim 1, wherein the reactant gas outlet is disposed at a position at which produced water collects when the vehicle travels downhill.

6. The fuel cell according to claim 5, wherein the produced water collecting at a position close to the reactant gas outlet is discharged due to a weight thereof in a low-power section due to the downhill travel of the vehicle.

7. A fuel cell vehicle, comprising:
a fuel cell frame;
a produced water drain unit disposed under the fuel cell frame; and
a fuel cell mounted on the fuel cell frame, the fuel cell comprising:
a cell stack comprising a plurality of unit cells stacked in a forward travel direction of the fuel cell vehicle;
an enclosure disposed so as to surround at least a portion of the cell stack; and
an end plate configured to support the plurality of unit cells of the cell stack, wherein the end plate has a reactant gas inlet and a reactant gas outlet disposed further forward than the cell stack in the forward travel direction of the fuel cell vehicle.

8. The fuel cell vehicle according to claim 7, wherein the produced water drain unit is located closer to a ground than the reactant gas outlet of the fuel cell.

9. The fuel cell vehicle according to claim 7, wherein the produced water drain unit is connected to an air inlet and an air outlet of the fuel cell.

10. The fuel cell vehicle according to claim 7, wherein the produced water drain unit is oriented at a same angle as the reactant gas inlet and the reactant gas outlet of the fuel cell.

11. The fuel cell vehicle according to claim 7, wherein the end plate is disposed on at least one of two end portions of the cell stack.

12. The fuel cell vehicle according to claim 7, wherein the reactant gas outlet is located closer to a ground than the reactant gas inlet.

13. The fuel cell vehicle according to claim 12, wherein an air outlet is located so as to be spaced apart from an air inlet in a diagonal direction, and a hydrogen outlet is located so as to be spaced apart from a hydrogen inlet in a diagonal direction.

14. The fuel cell vehicle according to claim 7, wherein the reactant gas outlet is disposed at a position at which produced water collects when the fuel cell vehicle travels downhill.

15. A fuel cell, comprising:
a cell stack comprising a plurality of unit cells stacked laterally in an x-axis direction;
an enclosure disposed so as to surround at least a portion of the cell stack; and
an end plate configured to support the plurality of unit cells of the cell stack, wherein the end plate has a reactant gas inlet and a reactant gas outlet disposed further toward a front portion of the fuel cell than the cell stack in the x-axis direction.

16. The fuel cell according to claim 15, wherein the end plate is disposed on at least one of two end portions of the cell stack.

17. The fuel cell according to claim 15, wherein the reactant gas outlet is located lower than the reactant gas inlet in a z-axis direction.

18. The fuel cell according to claim 17, wherein an air outlet is located so as to be spaced apart from an air inlet in a diagonal direction, and a hydrogen outlet is located so as to be spaced apart from a hydrogen inlet in a diagonal direction.

19. The fuel cell according to claim 15, wherein the reactant gas outlet is disposed at a position configured to collect produced water when the front portion of the fuel cell is tilted downward.

20. The fuel cell according to claim 15, wherein the cell stack further comprises:
a supply manifold configured to receive reactant gases; and
a discharge manifold configured to collect a residual gas and through which the residual gas is configured to be discharged outside the fuel cell.
